(19) United States
(12) Patent Application Publication
(10) Pub. No.: US 2025/0085198 A1
(43) Pub. Date: Mar. 13, 2025

(54) SUBSTATION OIL SAMPLING ROBOT

(71) Applicant: STATE GRID SHANGHAI MUNICIPAL ELECTRIC POWER COMPANY, Shanghai (CN)

(72) Inventors: Yingke Mao, Shanghai (CN); Chengchen Qian, Shanghai (CN); Jun Wu, Shanghai (CN); Xinqi Cui, Shanghai (CN); Qi Ni, Shanghai (CN); Xiaqing Meng, Shanghai (CN); Zhengyi Zhu, Shanghai (CN); Qian Heng, Shanghai (CN); Yang Ding, Shanghai (CN); Qiong Wu, Shanghai (CN); Fei Jiang, Shanghai (CN); Meng Sun, Shanghai (CN)

(21) Appl. No.: 18/726,833

(22) PCT Filed: Dec. 7, 2022
(86) PCT No.: PCT/CN2022/137110

§ 371 Date: Jul. 5, 2024

(30) Foreign Application Priority Data
Aug. 10, 2022 (CN) 202210955404.0

(51) Int. Cl. G01N 1/10; B25J 5/00; B25J 9/16

(52) U.S. Cl. CPC G01N 1/10; B25J 5/007; B25J 9/1679; B25J 9/1697

(57) ABSTRACT

A substation oil sampling robot comprises a smart mobile component, a robot arm grasping member, auxiliary sampling components, and auxiliary sampling platform components. The robot arm grasping member comprises a robot arm body fixedly mounted on the smart mobile component and a robot gripper unit. The auxiliary sampling components comprise sample bottles and a valve opening and closing tool, and the robot gripper unit is arranged with a first gripping portion matched with the sample bottles and a second gripping portion matched with the valve opening and closing tool. The sampling platform components comprise an auxiliary sampling tool connected with the pipeline. The pipeline is arranged with a pipeline valve. The auxiliary sampling tool comprises an auxiliary valve, an auxiliary sampling piping component, and an auxiliary sampling piping component support, and the outlet of the pipeline valve is in communication with the inlet of the auxiliary sampling piping component.

### TECHNICAL FIELD

The present disclosure relates to a field of substation oil sampling technology, and in particular, to a substation oil sampling robot.

### BACKGROUND

Traditional substations usually conduct manual sampling and inspection of the transformer oil. As most sampling sites are located in high risk production areas, the staff needs to use multiple protective measures and complicated safety procedures, resulting in problems of inconvenient and insufficient inspection. Moreover, manual sampling has shortcomings such as non-standard operation, high labor intensity, low efficiency, and imprecise sampling process.

Solutions of oil sampling robots for conducting oil sampling have been provided. For example, Chinese patent publication document CN112229683A discloses a substation oil sampling robot. It comprises a travel mechanism, an oil sampling device disposed on the travel mechanism, a navigation device, a guide mechanism, a communication device, and a control device. Herein, the control device is electrically connected with the navigation device, to control the navigation device to guide the travel mechanism to the transformer oil sampling location along a predetermined path. In such a manner, the coarse positioning between the travel mechanism and the oil sampling location can be realized. Herein, the guide mechanism is located above the oil sampling device and electrically connected with the control device, and is configured to guide the oil sampling device under control of the control device, to make sure the oil sampling device to be aligned to the transformer oil sampling location. In such a manner, the fine positioning between the oil sampling device and the oil sampling location can be realized. Further, the control device is electrically connected with the communication device and the oil sampling device. It is configured to control the communication device to interact information with the electric valve disposed at the transformer oil sampling point when the travel mechanism arrives at the transformer oil sampling point, control actions of said electric valve disposed at the transformer oil sampling point, and further control the oil sampling device to conduct oil sampling at the transformer oil sampling site.

The abovementioned solution needs an electromagnetic valve to be mounted at the transformer oil sampling site, and has poor versatility and high installation and maintenance cost.

### SUMMARY

To resolve the above-mentioned existing problems, the present disclosure aims to provide a substation oil sampling robot which improves working efficiency and safety.

To achieve the above objective, the present disclosure provides a technical solution as follow.

A substation oil sampling robot comprises a smart mobile component. The robot is characterized by comprising a robot arm grasping member, auxiliary sampling components, and auxiliary sampling platform components;

The robot arm grasping member comprises a robot arm body unit and a robot gripper unit, and the robot gripper unit is mounted at one end of the robot arm body unit, and another end of the robot arm body is fixedly mounted on the smart mobile component;

The auxiliary sampling components comprise sample bottles and a valve opening and closing tool, and the robot gripper unit is arranged with a first gripping portion matched with the sample bottles and a second gripping portion matched with the valve opening and closing tool;

The sampling platform components comprise an auxiliary sampling tool connected with the pipeline. The pipeline is arranged with a pipeline valve. The auxiliary sampling tool comprises an auxiliary valve, an auxiliary sampling piping component, and an auxiliary sampling piping component support, wherein the auxiliary sampling piping component is fixedly arranged on the auxiliary sampling piping component support, and the auxiliary valve is connected with the auxiliary sampling piping component. The outlet of the pipeline valve is in communication with the inlet of the auxiliary sampling piping component.

Preferably, the robot gripper unit may comprise a gripper support, and a first mechanical gripper and a second mechanical gripper which are arranged on the two sides of the gripper support, the gripper portions of the first mechanical gripper and the second mechanical gripper may be shaped to match with the shape of the sample bottles, and the gripper support may be arranged on a side with an electromagnet and valve tool fixing pins.

Preferably, the first mechanical gripper and the second mechanical gripper both may have a mechanical gripper structure, which comprises a push rod mounting base, an electric push rod, a gripper swing arm, and a gripper; the push rod mounting base may be fixedly mounted on the gripper support, one end of the gripper swing arm may be rotatably mounted on the gripper support, one end of the electric push rod may be rotatably connected with the push rod mounting base, another end of the electric push rod may be rotatably connected with the gripper swing arm, and the gripper may be fixedly arranged on a side of the gripper swing arm opposite to the electric push rod.

Preferably, the first mechanical gripper and the second mechanical gripper both may have a mechanical gripper structure, which comprises a push rod mounting base, an electric push rod, a gripper swing arm, and a gripper; the push rod mounting base may be fixedly mounted on the gripper support, one end of the gripper swing arm may be rotatably mounted on the gripper support, one end of the electric push rod may be rotatably connected with the push rod mounting base, another end of the electric push rod may be rotatably connected with the gripper swing arm, and the gripper may be fixedly arranged on a side of the gripper swing arm opposite to the electric push rod.

Preferably, the robot gripper unit may further comprise a vision camera mounted on the gripper support.

Preferably, the valve opening and closing tool may comprise a valve opening and closing tool plate and valve fixing pins, the valve opening and closing tool plate may be provided with a magnetic material mating with the electromagnet, the valve opening and closing tool plate may be provided with mounting holes corresponding to the valve tool fixing pins, and the valve fixing pins may be mounted on the valve opening and closing tool plate and arranged to fit distribution of the holes in the valve.

Preferably, the auxiliary sampling components may further comprise a tool carrier and a valve opening and closing tool carrier, wherein the tool carrier may be fixedly arranged on the smart mobile component, and the valve opening and closing tool carrier may be fixedly arranged on the tool carrier.

Preferably, the sample bottles may comprise a clean-up sampling bottle and an oil sampling bottle.

Preferably, the valve opening and closing tool carrier may comprise a permanent magnet and a base.

Preferably, the auxiliary sampling platform component may further comprise an oil sampling bottle carrier, an auxiliary sampling tool plate, and a third permanent magnet, wherein the auxiliary sampling piping component support may be fixedly arranged on one side of the auxiliary sampling tool plate, and the third permanent magnet may be fixedly arranged on another side of the auxiliary sampling tool plate opposite to the auxiliary sampling piping component support.

Preferably, the auxiliary sampling piping component support may be mounted at a location to ensure that the outlet of the auxiliary sampling piping component is right above the bottle mouth of the oil sampling bottle disposed on the oil sampling bottle carrier.

Preferably, the third permanent magnet fixedly arranged on the auxiliary sampling tool plate is plural in number.

Compared with the prior art, the present disclosure has following advantages.

(1) To conduct oil sampling, the present disclosure provides the valve opening and closing tool and the auxiliary sampling tool to achieve valve switching of the transformer pipeline. The auxiliary sampling tool has a simple structure and is convenient in maintenance. It has good dexterity, achieves universality of oil sampling operations, and has high economic benefit.

(2) Due to the auxiliary sampling platform component according to the technical solution, the oil sampling robot is suitable for various oil sampling scenarios, and has higher economic benefit.

(3) The oil sampling robot according to the technical solution can conduct oil sampling in dangerous sites. It replaces manual sampling and ensures safety of the personnel.

### BRIEF DESCRIPTION OF THE DRAWINGS

FIG. 1 is a schematic structural view of a device of the present disclosure;

FIG. 2 is a schematic structural view illustrating auxiliary sampling components of the present disclosure;

FIG. 3 is a schematic structural view illustrating a large valve opening and closing tool of the present disclosure;

FIG. 4 is a schematic structural view illustrating a large valve opening and closing tool carrier of the present disclosure;

FIG. 5 is a schematic structural view illustrating a small valve opening and closing tool of the present disclosure;

FIG. 6 is a schematic structural view illustrating a small valve opening and closing tool carrier of the present disclosure;

FIG. 7 is a front view of a robot arm of the present disclosure;

FIG. 8 is a top view of a robot arm of the present disclosure;

FIG. 9 is a front view of a robot gripper unit of the present disclosure;

FIG. 10 is a right side view of a robot gripper unit of the present disclosure;

FIG. 11 is a top view of a robot gripper unit of the present disclosure;

FIG. 12 is a schematic structural view of auxiliary sampling platform components of the present disclosure;

FIG. 13 is a front view of an auxiliary sampling tool of the present disclosure;

FIG. 14 is a left side view of an auxiliary sampling tool of the present disclosure;

FIG. 15 is a schematic view illustrating a state in which a robot gripper of the present disclosure grabs an oil sampling bottle;

FIG. 16 is a schematic view which shows a vision camera of the present disclosure identifying a state of a large valve;

FIG. 17 is a schematic view which shows a vision camera of the present disclosure identifying a state of a small valve;

FIG. 18 is a schematic view which shows an oil sampling bottle is set on an oil sampling bottle carrier by means of a substation oil sampling robot of the present disclosure;

FIG. 19 is a schematic view illustrating a state in which a substation oil sampling robot of the present disclosure sets an oil sampling bottle on an oil sampling bottle carrier;

FIG. 20 is a schematic view illustrating a state in which a substation oil sampling robot of the present disclosure grabs a large valve opening and closing tool;

FIG. 21 is a schematic view illustrating a state in which a robot arm of the present disclosure drives a robot gripper to open a pipeline valve;

FIG. 22 is a schematic view illustrating a state in which an oil sampling bottle containing oil sample is grabbed by means of a robot arm of the present disclosure;

FIG. 23 is a schematic view illustrating a state in which oil sample contained in an oil sampling bottle of the present disclosure is poured into a clean-up sampling bottle;

In the drawings: 1. auxiliary sampling tool platform; 2. smart mobile component; 3. robot arm body; 4. robot gripper unit; 5. auxiliary sampling tool component; 101. clean-up sampling bottle; 102. oil sampling bottle; 103. small valve opening and closing tool; 104. small valve opening and closing tool carrier; 105. large valve opening and closing tool; 106. large valve opening and closing tool carrier; 107. tool carrier; 702. fixing pins; 703. valve opening and closing tool plate; 601. large valve opening and closing tool base; 602. first permanent magnet; 401. small valve opening and closing tool base; 402. second permanent magnet; 51. auxiliary sampling tool; 52. pipeline; 53. pipeline valve; 501. small valve; 502. auxiliary sampling piping component; 503. auxiliary sampling piping component support; 504. auxiliary sampling tool plate; 505. oil sampling bottle carrier; 506. third permanent magnet; 301. vision camera; 302. gripper support; 303. gripper adapter plate; 304. first pivot pin; 305. electromagnet; 306. valve tool fixing pins; 307. push rod mounting base; 308. electric push rod; 309. second pivot pins; 310. gripper swing arm; 311. gripper.

### DETAILED DESCRIPTION

To make purposes, technical solutions and advantages of embodiments of the present disclosure more clear, the technical solutions of the embodiments of the present disclosure are clearly and completely described below with reference to the accompanying drawings in the embodiments of the present disclosure. Apparently, the described embodiments are merely a part rather than all of the embodiments of the present disclosure. It should be understood that components of the embodiments of the present disclosure illustrated and shown in the drawings may be arranged and designed in various ways.

The detail descriptions of the embodiments of the present disclosure with reference to the accompanying drawings are merely specified embodiments of the present disclosure, and are not intended to limit the present disclosure. All other embodiments obtained by those of ordinary skill in the art based on the embodiments of the present disclosure without creative efforts shall fall within the protection scope of the present disclosure.

It should be noted that these same reference numerals and characters indicate same parts in these drawings. Once one reference numeral or character is defined in one drawing, it is not necessary to be defined or explained again in other drawings.

It should be noted that the terms, such as “center”, “upper”, “lower”, “left”, “right”, “vertical”, “horizontal”, “inner”, and “outer” as used in the description, refer to position and orientation relationships as shown in the drawings or in accordance with those relationships during normal operations for convenience of description and for the purpose of simplicity. They are not intended to indicate or hint a limitation in terms of specific orientation or configuration and operation with specific orientation to the described device or element, and should not be regarded as a limitation to the present disclosure.

It should be noted that the terms “first” and “second” are used for convenience of description and are not intended to indicate or imply relative importance or hint the quantity of components. Hence, it is understood that components defined by the terms “first” and “second” are intended to indicate or hint one or more of such components. Unless explicitly stated otherwise, it is understood that “the plurality of” as used in the description refer to two or more.

In addition, the terms such as “vertical” and “horizontal” means the components are substantially rather than perfectly vertical or horizontal. For example, the term “horizontal” is intended to indicate that a component is more horizontal than vertical, that is, the component may be slightly tilted and not perfectly horizontal.

### Embodiment 1

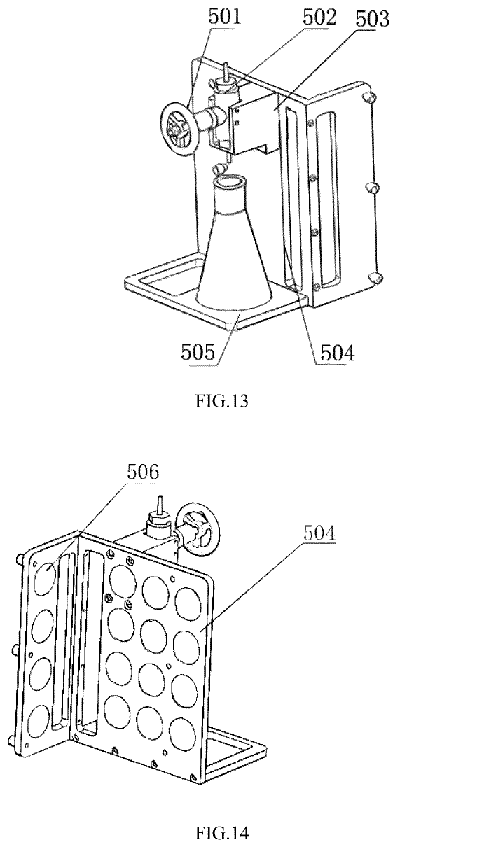

Referring to FIGS. 1, 12, and 13, the present embodiment provides a substation oil sampling robot, which comprises a smart mobile component 2, a robot arm grasping member, auxiliary sampling components 1, and auxiliary sampling platform components 5;

The robot arm grasping member comprises a robot arm body 3 and a robot gripper unit 4, the robot gripper unit 4 is mounted at one end of the robot arm body 3, and another end of the robot arm body is fixedly mounted on the smart mobile component 2;

The auxiliary sampling components 1 comprises sample bottles and a valve opening and closing tool. The robot gripper unit 4 is arranged with a first gripping portion matched with the sample bottles and a second gripping portion matched with the valve opening and closing tool;

The sampling platform components 5 comprise an auxiliary sampling tool connected with the pipeline 52. The pipeline is arranged with a pipeline valve 53. The auxiliary sampling tool comprises an auxiliary valve 501, an auxiliary sampling piping component 502, and an auxiliary sampling piping component support 503, wherein the auxiliary sampling piping component 502 is fixedly disposed on the auxiliary sampling piping component support 503, and the auxiliary valve 501 is connected with the auxiliary sampling piping component 502. The outlet of the pipeline valve 53 is in communication with the inlet of the auxiliary sampling piping component 502.

The working principle is as follows. During oil sampling, firstly the smart mobile component 2 is remotely controlled to move to a specified position, and then the robot arm body 3 is driven to reach one of the sample bottles and grab it by means of the robot gripper unit 4. After that, the robot arm body 3 is driven to move to a position below the outlet of the auxiliary sampling piping component 502 and put away the said sample bottle.

The robot arm body 3 is driven to reach the valve opening and closing tool and grab it by means of the robot gripper unit 4. When the valve opening and closing tool is held by means of the robot gripper unit 4, valve positions of the pipeline valve 53 and the auxiliary valve 501 are determined by a vision camera arranged on the robot gripper unit 4. The robot gripper unit 4 driven by means of the robot arm body 3, use the valve opening and closing tool to rotate and thus open the pipeline valve 53 and the auxiliary valve 501 in turn, so as to enable oil sampling with the said sample bottle.

After oil sampling, the robot gripper unit 4 driven by means of the robot arm body 3, use the valve opening and closing tool to reversely rotate and thus close the auxiliary valve 501 and the pipeline valve 53 in turn. After that, by means of the robot gripper unit 4, the valve opening and closing tool is moved to a specified position, the said sample bottle which contains oil sample is grabbed and moved to a specified position. In this way, a process of oil sampling is performed by the robot.

Due to the arrangements of the robot arm, the auxiliary sampling components, and the auxiliary sampling tool, the substation oil sampling robot provided by the present embodiment achieves high efficient automatic sampling. Moreover, the auxiliary sampling tool which has a good structural design and is convenient in maintenance, significantly increases economic benefit of oil sampling.

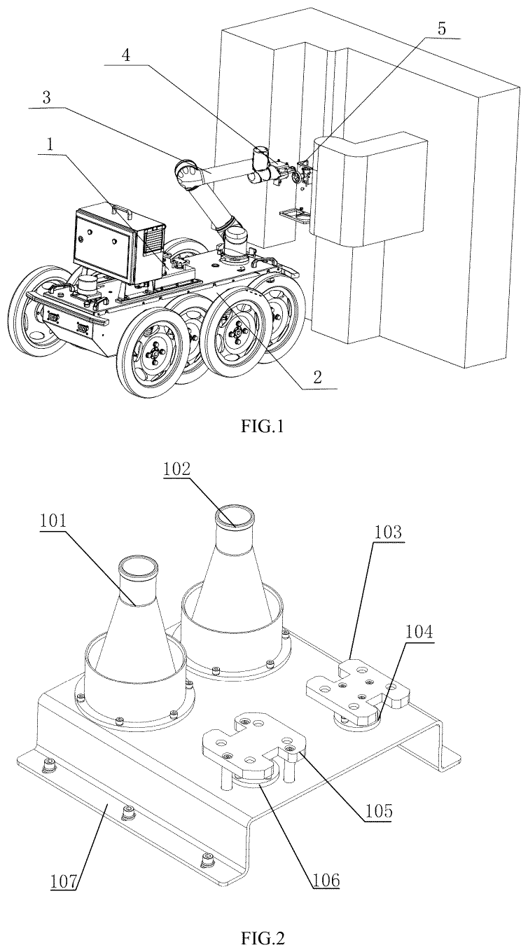

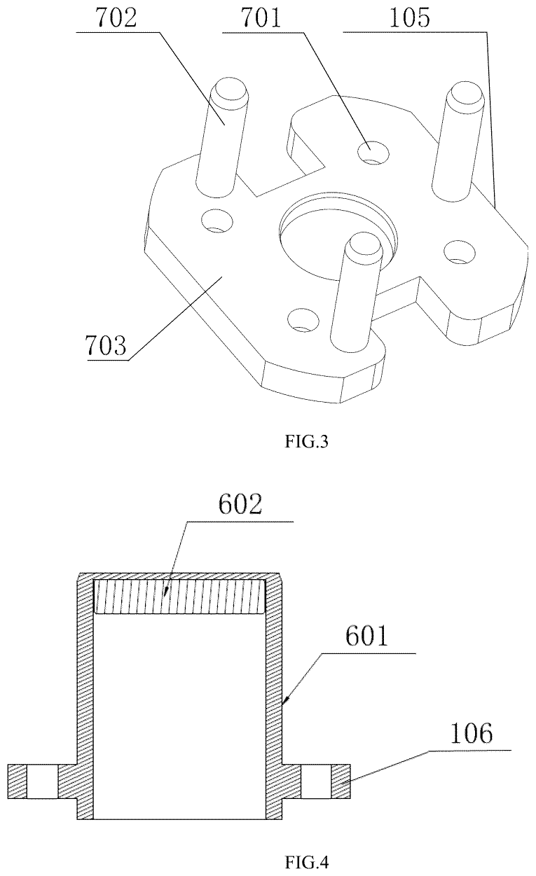

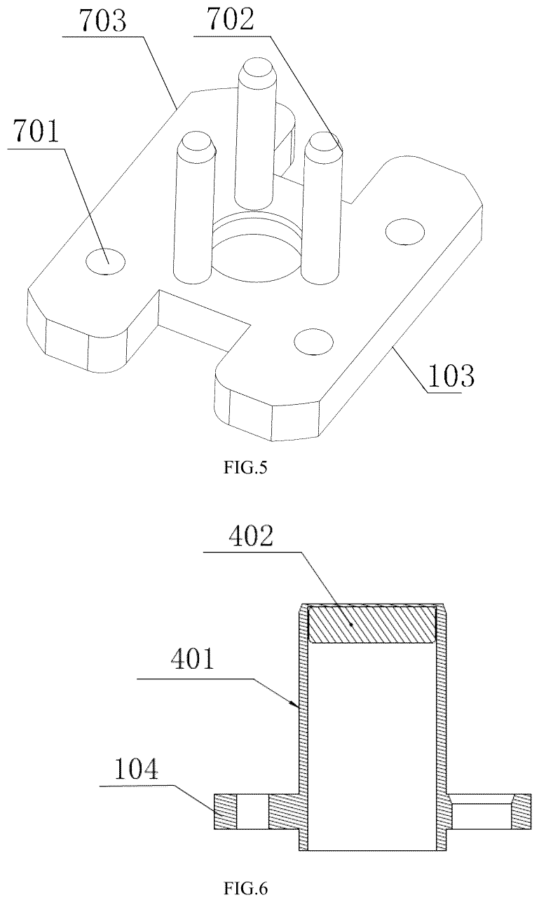

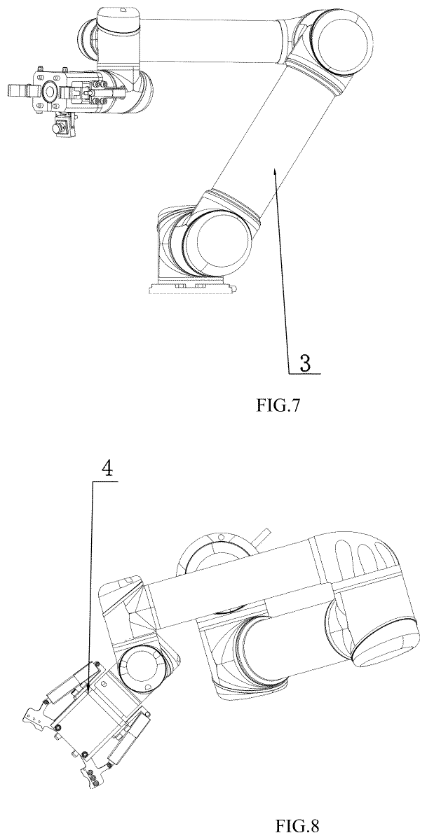

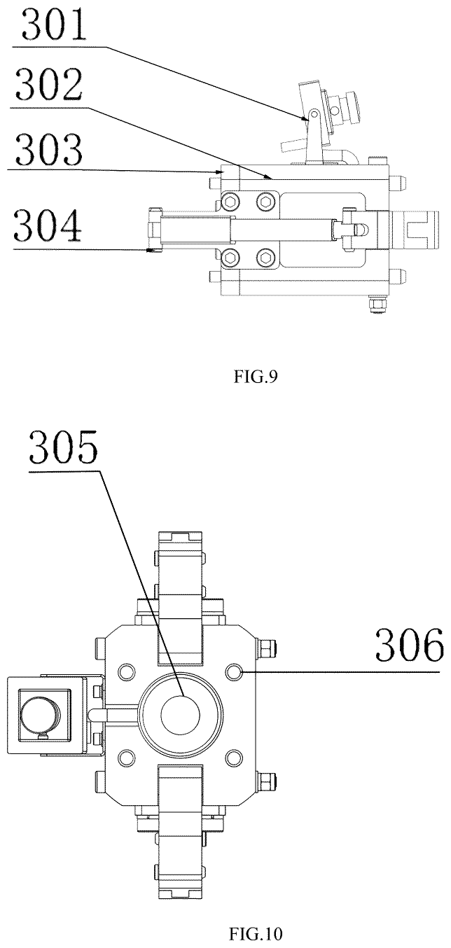

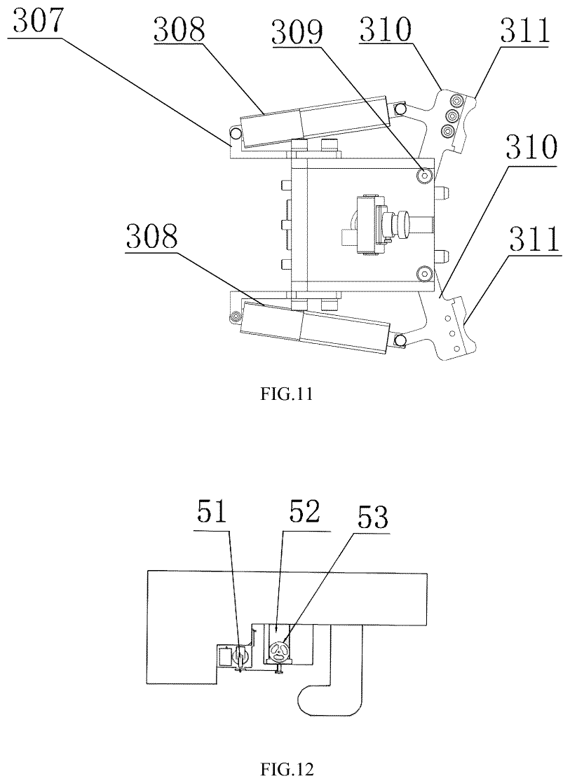

Alternatively, referring to FIGS. 2-14, the robot gripper unit 4 comprises a gripper support 302, and a first mechanical gripper and a second mechanical gripper which are arranged on the two sides of the gripper support. The gripper portions of the first mechanical gripper and the second mechanical gripper are shaped to match with the shape of the sample bottles. The gripper support 302 is arranged on a side with an electromagnet 305 and valve tool fixing pins 306, and is arranged on the side opposite to the electromagnet 305 with a gripper adapter plate 303 for connection with the robot arm body 3.

The first mechanical gripper and the second mechanical gripper both have a mechanical gripper structure, which comprises a push rod mounting base 307, an electric push rod 308, a gripper swing arm 310, and a gripper 311. The push rod mounting base is fixedly mounted on the gripper support 302, and one end of the gripper swing arm 310 is rotatably mounted on the gripper support 302. One end of the electric push rod 308 is rotatably connected with the push rod mounting base 307, and another end of the electric push rod 308 is rotatably connected with the gripper swing arm 310. The gripper 311 is fixedly arranged on a side of the gripper swing arm 310 opposite to the electric push rod 308.

The said rotatable connection can be achieved by existing rotatable connection structures. In the present embodiment, it is achieved by pivot pins. Fox example, the gripper swing arm 310 may be mounted on the gripper support 302 by the second pivot pins 309, and one end of the electric push rod 308 may be connected with the push rod mounting base 307 by the first pivot pin 304.

The vision camera 301 of the robot gripper unit 4 is mounted on one side of the gripper support 302, to identify and determine valve positions of the auxiliary valve 501 and the pipeline valve 53.

The auxiliary sampling components 1 further comprises a tool carrier 107 and a valve opening and closing tool carrier. The tool carrier 107 is fixedly arranged on the smart mobile component 2, and the valve opening and closing tool carrier is fixedly arranged on the tool carrier 107.

The clean-up sampling bottle 101 and the oil sampling bottle 102 are disposed on the tool carrier 107. To make sure the sampled oil is clean, it is desirable to pour the oil sampled for the first time into the clean-up sampling bottle 101, and conduct oil sampling with the oil sampling bottle 102 for the second time.

The valve opening and closing tool carrier comprises a large valve opening and closing tool carrier 106 and a small valve opening and closing tool carrier 104. Herein, the large valve opening and closing tool carrier 106 comprises a first permanent magnet 602 and a large valve opening and closing tool base 601, and the first permanent magnet 602 is fixedly arranged at the bottom of the large valve opening and closing tool base 601. The small valve opening and closing tool carrier 104 comprises a second permanent magnet 402 and a small valve opening and closing tool base 401, and the second permanent magnet 402 is fixedly arranged at the bottom of the large valve opening and closing tool base 401.

In consideration of the valve opening and closing tool would be fixedly arranged with magnetic materials, the valve opening and closing tool carrier may be fixedly arranged with permanent magnets, to make sure the valve opening and closing tool can be stably fixed on the tool carrier 107.

The valve opening and closing tool comprises a valve opening and closing tool plate 703 and valve fixing pins 702, and the valve opening and closing tool plate 703 is provided with magnetic materials mating with the electromagnet 305. The valve opening and closing tool plate 703 is provided with mounting holes 701 corresponding to the valve tool fixing pins 306. The valve fixing pins 702 are mounted on the valve opening and closing tool plate 703 and arranged to fit distribution of the holes in the valve.

As existing valves usually have three through holes, the present embodiment provides three valve fixing pins. Apparently, the quantity of the valve fixing pins may be determined depending on the quantity of through holes of the valve, and distribution pattern of the three valve fixing pins and distances therebetween may be determined depending on the size of the valve. In the present embodiment, a large valve opening and closing tool 105 and a small valve opening and closing tool 103 are provided.

The auxiliary sampling platform components 5 further comprise an oil sampling bottle carrier 505, an auxiliary sampling tool plate 504, and a third permanent magnet 506. The auxiliary sampling piping component support 503 is fixedly arranged on one side of the auxiliary sampling tool plate 504, and the third permanent magnet is fixedly arranged on another side of the auxiliary sampling tool plate 504 opposite to the auxiliary sampling piping component support 503.

The third permanent magnet fixedly arranged on the auxiliary sampling tool plate is plural in number.

Working process

1. Referring to FIGS. 15, 18, and 19, the oil sampling robot may be remotely controlled to move to a sampling site, and then the oil sampling bottle 102 may be grabbed and put on the oil sampling bottle carrier 505 by the robot gripper unit 4.

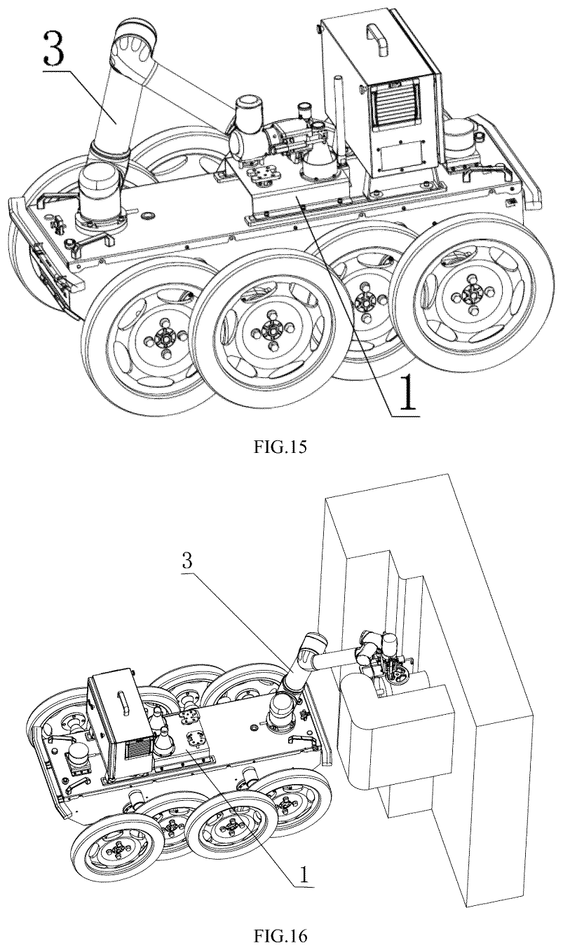

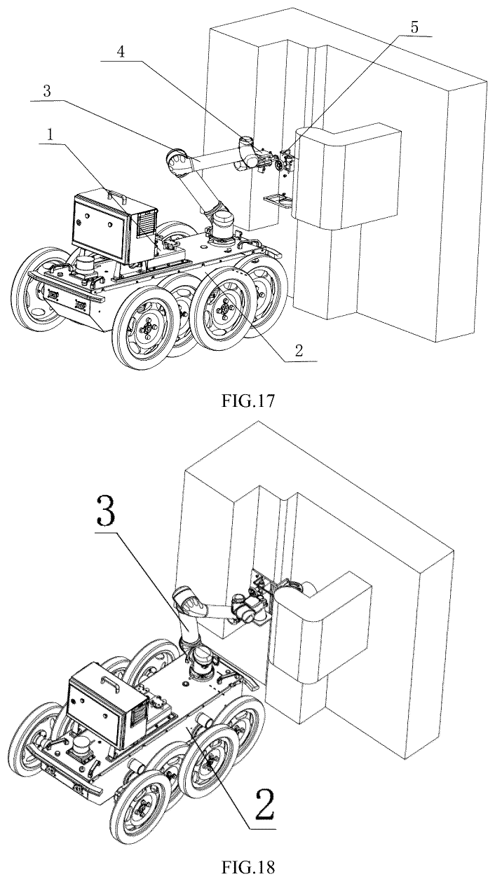

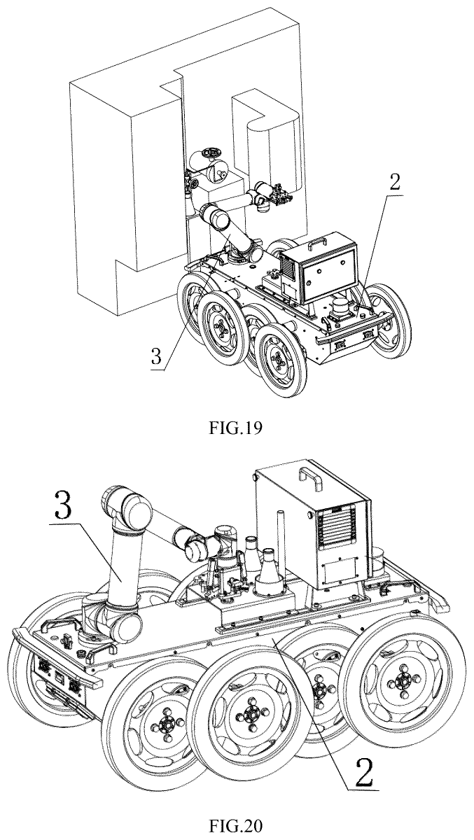

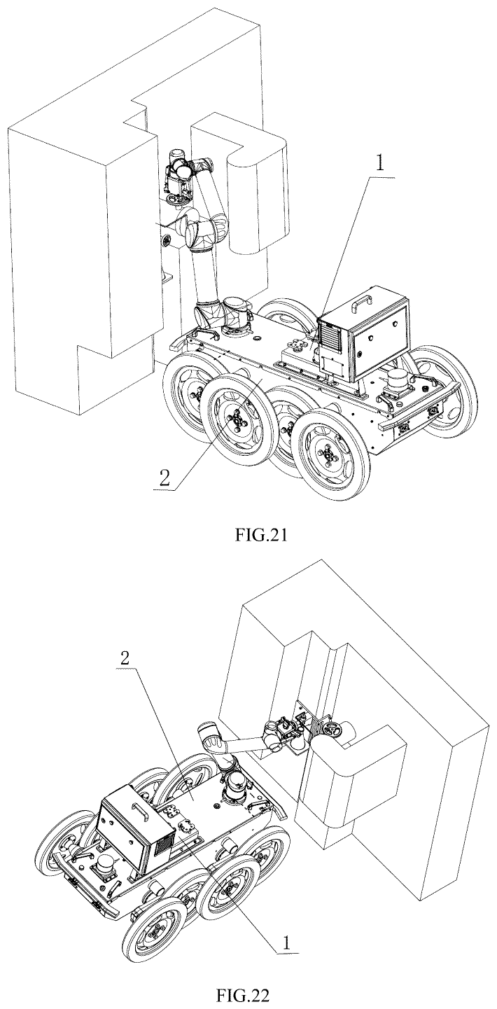

2. Referring to FIGS. 16, 17, 20, and 21, after the oil sampling bottle 102 is put away, the large valve opening and closing tool 106 may be held by the robot gripper unit 4, and valve position and state of the pipeline valve 53 may be identified and determined by the vision camera of the robot gripper unit 4. The robot arm body 3 may be moved to reach the pipeline valve 53 and insert the fixing pins 702 of the large valve opening and closing tool 106 into the holes of the pipeline valve 53, and the robot gripper unit 4 may be driven to rotate and thus open the pipeline valve 53. In a similar way to open the pipeline valve 53, the small valve opening and closing tool 103 may be used to open the auxiliary valve 501. Then, oil may be sampled and contained in the oil sampling bottle 102.

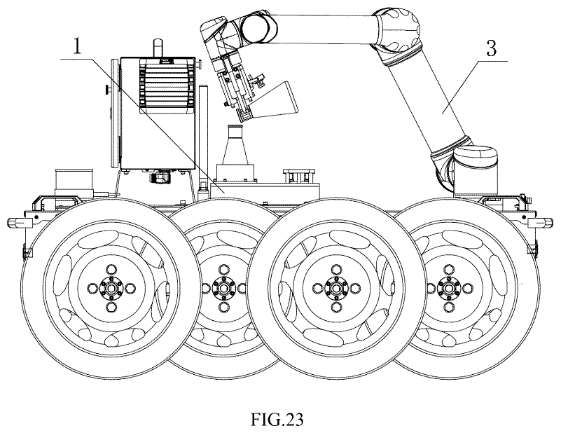

3. FIG. 22 is a schematic view illustrating a state in which an oil sampling bottle containing oil sample is grabbed by means of a robot arm of the present disclosure; FIG. 23 is a schematic view illustrating a state in which oil sample contained in an oil sampling bottle of the present disclosure is poured into a clean-up sampling bottle. As shown in the drawings, after oil sampling, the small valve opening and closing tool 103 may be driven to close the auxiliary valve 501. The oil sample contained in the oil sampling bottle 102 may be poured into the clean-up sampling bottle 101, and then the oil sampling bottle 102 may be put on the sample bottle carrier 505 again, to allow the step 2 to be repeated.

4. After oil sampling with the oil sampling bottle 102, the small valve opening and closing tool 103 may be driven to close the auxiliary valve 501. After the auxiliary valve 501 is closed, the small valve opening and closing tool 103 may be put on the small valve opening and closing tool carrier 104. The oil sampling bottle 102 may be grabbed by the robot gripper unit 4 and delivered to a specified position on the tool carrier 107. Then, the robot arm may be restored to the initial state, the oil sampling robot may be remotely controlled to move back. In this way, the whole process of oil sampling is performed by the robot.

Some preferred embodiments of the present disclosure have been described above in detail. It should be noted that for those of ordinary skill in the art, various modifications and changes can be made on the basis of the concept of the present disclosure without creative effort. On the basis of the concept of the present disclosure, all technical solutions obtained by those of ordinary skill in the art upon logical analysis, reasoning or some experiments based on the prior art shall fall within the protection scope of the present disclosure.

1. A substation oil sampling robot, comprising a smart mobile component (2), wherein the robot further comprises a robot arm grasping member, auxiliary sampling components (1), and auxiliary sampling platform components (5);
the robot arm grasping member comprises a robot arm body (3) and a robot gripper unit (4), and the robot gripper unit (4) is mounted at one end of the robot arm body (3), and another end of the robot arm body is fixedly mounted on the smart mobile component (2);
the auxiliary sampling components (1) comprise sample bottles and a valve opening and closing tool, and the robot gripper unit (4) is arranged with a first gripping portion matched with the sample bottles and a second gripping portion matched with the valve opening and closing tool;
the sampling platform components (5) comprise an auxiliary sampling tool connected with a pipeline (52), the pipeline is arranged with a pipeline valve (53), the auxiliary sampling tool comprises an auxiliary valve (501), an auxiliary sampling piping component (502), and an auxiliary sampling piping component support (503), the auxiliary sampling piping component (502) is fixedly arranged on the auxiliary sampling piping component support (503), the auxiliary valve (501) is connected with the auxiliary sampling piping component (502), and an outlet of the pipeline valve (53) is in communication with an inlet of the auxiliary sampling piping component (502).

2. The substation oil sampling robot according to claim 1,
wherein the robot gripper unit (4) comprise a gripper support (302), and a first mechanical gripper and a second mechanical gripper which are arranged on two sides of the gripper support (302), gripper portions of the first mechanical gripper and the second mechanical gripper are shaped to match with a shape of the sample bottles, and the gripper support (302) is provided on a side with an electromagnet (305) and valve tool fixing pins (306).

3. The substation oil sampling robot according to claim 2,
wherein the first mechanical gripper and the second mechanical gripper both have a mechanical gripper structure, which comprises a push rod mounting base (307), an electric push rod (308), a gripper swing arm (310), and a gripper (311); the push rod mounting base (307) is fixedly mounted on the gripper support (302), one end of the gripper swing arm (310) is rotatably mounted on the gripper support (302), one end of the electric push rod (308) is rotatably connected with the push rod mounting base (307), another end of the electric push rod (308) is rotatably connected with the gripper swing arm (310), and the gripper (311) is fixedly arranged on a side of the gripper swing arm (310) opposite to the electric push rod (308).

4. The substation oil sampling robot according to claim 1,
wherein the robot gripper unit (4) further comprises a vision camera (301) mounted on the gripper support (302).

5. The substation oil sampling robot according to claim 1,
wherein the valve opening and closing tool comprises a valve opening and closing tool plate (703) and valve fixing pins (702), the valve opening and closing tool plate (703) is provided with a magnetic material mating with the electromagnet (305), the valve opening and closing tool plate (703) is provided with mounting holes (701) corresponding to the valve tool fixing pins (306), and the valve fixing pins (702) are mounted on the valve opening and closing tool plate (703) and arranged to fit distribution of valve holes.

6. The substation oil sampling robot according to claim 1,
wherein the auxiliary sampling components (1) further comprise a tool carrier (107) and a valve opening and closing tool carrier, wherein the tool carrier (107) is fixedly arranged on the smart mobile component (2), and the valve opening and closing tool carrier is fixedly arranged on the tool carrier (107).

7. The substation oil sampling robot according to claim 1,
wherein the sample bottles comprise a clean-up sampling bottle (101) and an oil sampling bottle (102).

8. The substation oil sampling robot according to claim 1,
wherein the valve opening and closing tool carrier comprises a permanent magnet and a base.

9. The substation oil sampling robot according to claim 1,
wherein the auxiliary sampling platform component (5) further comprises an oil sampling bottle carrier (505), an auxiliary sampling tool plate (504), and a third permanent magnet (506), the auxiliary sampling piping component support (503) is fixedly arranged on one side of the auxiliary sampling tool plate (504), and the third permanent magnet is fixedly arranged on another side of the auxiliary sampling tool plate (504) opposite to the auxiliary sampling piping component support (503).

10. The substation oil sampling robot according to claim 1,
wherein the third permanent magnet fixedly arranged on the auxiliary sampling tool plate is plural in number.
